(19) United States
(12) Patent Application Publication
(10) Pub. No.: US 2006/0251168 A1
(43) Pub. Date: Nov. 9, 2006

(54) Video encoding and decoding methods and corresponding devices

(75) Inventors: Cecile Dufour, Paris (FR); Gwenaëlle Marquant, Liffre (FR); Stéphane Valente, Paris (FR)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/551,026

(22) PCT Filed: Mar. 30, 2004
(86) PCT No.: PCT/IB04/01010

§ 371 Date: Sep. 29, 2005

(30) Foreign Application Priority Data
Apr. 4, 2003 (EP) 03290852.7

(51) Int. Cl. H04N 7/12; H04N 11/04; H04B 1/66; H04N 11/02

(52) U.S. Cl. 375/240.12

(57) ABSTRACT

The invention relates to an encoding method applied to an input video sequence corresponding to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream. According to said method, said syntax comprises an additional syntactic information provided for describing independently the type of temporal prediction of the various channels, said additional syntactic information being a syntactic element placed at the image level in the coded bitstream and either shared by all existing channels or specific for each of said channels.

### FIELD OF THE INVENTION

The present invention relates to the field of video compression and, for instance, to the video coding standards of the MPEG family (MPEG-1, MPEG-2, MPEG-4) and to the video recommendations of the ITU-H.26× family (H.261, H.263 and extensions, H.264). More specifically, this invention concerns an encoding method applied to an input video sequence corresponding to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels.

The invention also relates to a corresponding encoding device, to a transmittable video signal consisting of a coded bitstream generated by such an encoding device, and to a method and a device for decoding a video signal consisting of such a coded bitstream.

### BACKGROUND OF THE INVENTION

In the first video coding standards and recommendations (up to MPEG-4 and H.264), the video was assumed to be rectangular and to be described in terms of a luminance channel and two chrominance channels. With MPEG-4, an additional channel carrying shape information has been introduced. Two modes are available to compress those channels: the INTRA mode, where each channel is encoded by exploiting the spatial redundancy of the pixels in a given channel for a single image, and the INTER mode, exploiting the temporal redundancy between separate images. The INTER mode relies on a motion-compensation technique, which describes an image from one (or more) previously decoded image(s) by encoding the motion of pixels from one image to the other. Usually, the image to be encoded is partitioned into independent blocks, each of them being assigned a motion vector. A prediction of the image is then constructed by displacing pixel blocks from the reference image(s) according to the set of motion vectors (luminance and chrominance channels share the same motion description). Finally, the difference (called the residual signal) between the image to be encoded and its motion-compensated prediction is encoded in the INTER mode to further refine the decoded image. However, the fact that all pixel channels are described by the same motion information is a limitation damaging the compression efficiency of the video coding system.

### SUMMARY OF THE INVENTION

It is therefore an object of the invention to propose a video encoding method in which said drawback is avoided by adapting the way the temporal prediction is formed.

To this end, the invention relates to a method such as defined in the introductory part of the description and which is characterized in that said syntax comprises an additional syntactic information provided for describing independently, at the image level, the type of temporal prediction of the various channels, said predictions being chosen within a list that comprises the following situations:
the temporal prediction is formed by directly applying the motion field sent by the encoder on one or more reference pictures;
the temporal prediction is a copy of a reference image;
the temporal prediction is formed by the temporal interpolation of the motion field;
the temporal prediction is formed by the temporal interpolation of the current motion field and further refined by the motion field sent by the encoder.

The invention also relates to a corresponding encoding device, to a transmittable video signal consisting of a coded bitstream generated by such an encoding device, and to a method and a device for decoding a video signal consisting of such a coded bitstream.

### DETAILED DESCRIPTION OF THE INVENTION

According to the invention, it is proposed to introduce in the encoding syntax used by the video standards and recommendations a new syntactic element supporting their lack of flexibility and opening new possibilities to encode more efficiently and independently the temporal prediction of various channels. This additional syntactic element, called for instance “channel temporal prediction”, takes the following symbolic values:

Motion_compensation

Temporal_copy

Temporal_interpolation

Motion_compensated_temporal_interpolation, and the meaning of these values is:

a) motion_compensation: the temporal prediction is formed by directly applying the motion field sent by the encoder on one or more reference pictures (this default mode is implicitly the INTER coding mode of most of the current coding systems);

b) temporal_copy: the temporal prediction is a copy of a reference image;

c) temporal_interpolation: the temporal prediction is formed by the temporal interpolation of the motion fields;

d) motion_compensated_temporal_interpolation: the temporal prediction is formed by the temporal interpolation of the current motion field and further refined by the motion field sent by the encoder.

The words “temporal interpolation” must be understood in a broad sense, i.e. as meaning any operation of the type defined by an expression such as Vnew=a.V1+b.V2+K where V1 and V2 designate previously decoded motion fields, a and b designate coefficients respectively assigned to said past and future motion fields, K designates an offset and Vnew is the new motion field thus obtained. It can therefore be seen that the particular case of the temporal copy is, in fact, included in the more general case of the temporal interpolation, for b=0 and K=0 (or a=0 and K=0).

The additional syntactic element thus proposed is expected to be placed at the image level (or VOP level in MPEG-4 terminology) in the coded bitstream that has to be stored (or transmitted to the decoding side), and either one syntactic element is placed in an INTER picture, its meaning being then shared by all the channels present in the VOP, or a syntactic element is provided for each present channel.

This invention may be used in the identified situations where the encoding of a motion vector set for all channels is not necessary. For instance, in sequences where there is little motion between successive frames, instead of encoding a full set of motion vectors repeating that each macroblock has no motion, it may be advantageous to signal that no motion is present. In other situations, instead of encoding a motion vector field, it may be advantageous to signal that the prediction of the motion vectors should be constructed by interpolating the image from several reference images (in this case, the decoder has to estimate a motion field between several reference images and interpolate it to create the prediction of the current image), or a motion vector field can still be interpreted not directly from one or several reference image(s), but instead from the temporal interpolation of the reference images. Moreover, there are situations where the way of constructing the temporal prediction can be switched on a channel basis. For instance, in the case of a sequence with a shape channel, it is possible that the shape information does not change much, whereas the luminance and chrominance channels carry varying information (it is for instance the case with a video depicting a rotating planet: the shape is always a disc, but the texture of it depends on the planet rotation). In this situation, the shape channel can be recovered by temporal copy, and the luminance and chrominance channels by motion compensated temporal interpolation.

1. An encoding method applied to an input video sequence corresponding to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels, said method being further characterized in that said syntax comprises an additional syntactic information provided for describing independently, at the image level, in said coded generated bitstream, the type of temporal prediction of the various channels, said predictions being chosen within a list that comprises the following situations:
the temporal prediction is formed by directly applying the motion field sent by the encoder on one or more reference pictures
the temporal prediction is a copy of a reference image
the temporal prediction is formed by the temporal interpolation of the motion field;
the temporal prediction is formed by the temporal interpolation of the current motion field and further refined by the motion field sent by the encoder.

2. An encoding method according to claim 1, characterized in that said additional syntactic information consists of a syntactic element whose meaning is specific for each present channel.

3. An encoding method according to claim 1, characterized in that said additional syntactic information is a syntactic element whose meaning is shared by all existing channels.

4. An encoding device processing an input video sequence that corresponds to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels, said encoding device being provided for carrying out the encoding method according to claim 1.

5. A transmittable video signal consisting of a coded bitstream generated by an encoding device processing an input video sequence that corresponds to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels, said transmittable video signal moreover including an additional syntactic information provided for describing independently, at the image level, in said coded generated bitstream, the type of temporal prediction of the various channels, said predictions being chosen within a list that comprises the following situations:
the temporal prediction is formed by directly applying the motion field sent by the encoder on one or more reference pictures
the temporal prediction is a copy of a reference image
the temporal prediction is formed by the temporal interpolation of the motion field;
the temporal prediction is formed by the temporal interpolation of the current motion field and further refined by the motion field sent by the encoder.

6. A method for decoding a transmittable video signal consisting of a coded bitstream generated by an encoding device processing an input video sequence that corresponds to successive scenes subdivided into successive video object planes (VOPs) and generating, for coding all the video objects of said scenes, a coded bitstream constituted of encoded video data in which each data item is described by means of a bitstream syntax allowing to recognize and decode all the elements of the content of said bitstream, said content being described in terms of separate channels, said transmittable video signal including an additional syntactic information provided for describing independently, at the image level, in said coded generated bitstream, the type of temporal prediction of the various channels, said predictions being chosen within a list comprising the following situations:
the temporal prediction is formed by directly applying the motion field sent by the encoder on one or more reference pictures
the temporal prediction is a copy of a reference image
the temporal prediction is formed by the temporal interpolation of the motion field;
the temporal prediction is formed by the temporal interpolation of the current motion field and further refined by the motion field sent by the encoder.

7. A decoding device for carrying out a decoding method according to claim 6.
